(19) United States
(12) Patent Application Publication
(10) Pub. No.: US 2025/0128196 A1
(43) Pub. Date: Apr. 24, 2025

(54) DESIGN FOR THE DAC AND HVAC INTEGRATION PROTOTYPE AND SAME

(71) Applicant: Qatar Foundation for Education, Science and Community Development, Doha (QA)

(72) Inventors: Abdulkarem Ibrahim Amhamed, Doha (QA); Yasser Abdellatif, Doha (QA); Ahmed Sodiq, Doha (QA)

(21) Appl. No.: 18/916,109

(22) Filed: Oct. 15, 2024

Related U.S. Application Data
(60) Provisional application No. 63/544,989, filed on Oct. 20, 2023.

(51) Int. Cl. B01D 46/00; B01D 46/42; B01D 53/04; F24F 8/108; F24F 8/167

(52) U.S. Cl. CPC B01D 46/0047; B01D 46/4263; B01D 53/0438; B01D 53/0446; F24F 8/108; F24F 8/167; B01D 2257/504; B01D 2257/80; B01D 2258/06; B01D 2259/40088; B01D 2279/50

(57) ABSTRACT

An air handling unit to pass air through the air handling unit to regulate the air within an indoor space is provided. The air handling unit includes at least one filter configured to filter the air, at least one cooler configured to cool the air to a low temperature, at least one heater configured to heat the air to a low temperature, and at least one humidifier configured to add moisture into the air.

### PRIORITY CLAIM

This application claims the benefit of and priority to U.S. Provisional Patent App. 63/544,989, filed Oct. 20, 2023, the entire disclosure of which is incorporated by reference herein.

### BACKGROUND

Air conditioning systems (also known as “HVAC systems”) serve as a primary tool to create a comfortable indoor area. However, air conditioning systems require high and consistent energy usage.

Air conditioning systems require a continued air flow rate (specifically during CO2 regeneration stages), appropriate CO2 concentration, and appropriate humidity are all vital to be regulated by an air conditioning system as any interruption may decrease productivity and personal wellbeing. In addition to the high efficacy required from air conditioning systems, air conditioning systems are subject to significant impacts on performance and energy consumption due to a variety of factors such as weather conditions or high-grade thermal energy requirements during CO2 regeneration.

One such air conditioning system contained in an Air Handling Unit (“AHU”) is a Direct Air Capture (“DAC”) system. DAC systems have a negative emission target, yet a more efficient system that consumes less energy is desired. Adjusting the DAC technology to utilize renewable energy is thus essential.

Some possible benefits of DAC and HVAC integration have been built on previous studies. It has been reported in the prior art that high levels of CO2 exposure lead to severe cognitive effects. Studies have shown that CO2 concentrations in the range of 4000 to 10,000 cause malaise, headache, and lethargy, while higher levels of 10,000 to 30,000 may cause metabolic changes, non-narcotic central nervous system, and electrolyte imbalances. One study discussed the possibility of utilizing a CO2 capture device within the ventilation system that allows for the circulation of indoor air for certain periods. Simulation results for the tropical summer and the winter season in Central Europe suggest that 30-60% of the energy used for air ventilation for cooling and heating can be saved compared to traditional systems.

One such proposal integrates CO2 collectors within an HVAC system for capturing CO2 from the exhaust stream prior to leaving a building. That system uses an ion-exchange resin sorbent and moisture swing technique to adsorb and regenerate CO2. One advantage of this approach is that it utilizes fan-free energy from the HVAC system and the high concentration of CO2 in the exhaust stream. According to their calculations, if this system were installed in 50% of existing commercial buildings, it could offset 0.1% of carbon emissions in the USA.

A study was conducted that suggested the potential for reducing energy requirements and operation costs in buildings by coupling DAC with HVAC in recirculation mode. However, the study also identified some issues with CO2 adsorbers, which can be expensive and have stability issues in the long run, necessitating replacement. Sorbents may also be exposed to thermal and mechanical stress, in addition to reactive chemicals, which can decrease their lifetime. Therefore, the success of HVAC/DAC coupling depends on the technical feasibility of using sorbents with long lifetimes and affordable costs. The economic viability of this approach is quantified by the potential energy savings achievable through HVAC/DAC integration in recirculation mode, resulting in lower operating costs (OPEX). Thus, the success of HVAC/DAC coupling is dependent on both the DAC technology and the effectiveness of its integration into the building's energy infrastructure. Despite DAC technology being in its early stages, coupling it with HVAC in buildings provides an energy-saving potential that can drive the technology towards mass adoption.

Microwave heating utilization as a regeneration method for a DAC unit has also been investigated in prior art in recent years. A previous study involved measuring the energy consumption required by a microwave oven and a conventional oven to regenerate the same amount of sorbent to compare the total energy required per unit mass of the regenerated sample and evaluate the potential benefits of microwave regeneration. The study revealed that microwave heating was an effective method for regenerating MGBIG carbonate, which could be facilitated by water molecules co-crystallized with carbonate in the guanidine crystals. Specifically, microwave heating at 2.54 GHz with 1250 W was up to 17 times faster than conventional conductive heating at 160° C., resulting in a 40% reduction in electrical energy consumption. These findings suggest that microwave regeneration may represent an energy-efficient approach for the fast regeneration of solid sorbents used for DAC. Another study presents the development of an all-electric regenerator that utilizes microwaves for the desorption of CO2 from air-capture sorbents. The effectiveness of this approach was tested through experiments that used nitrogen as a purge gas to produce enriched air containing 1 to 2 vol. % CO2. Results showed that productivities of up to 1.5 kg CO2/kgsorb./d were achieved with a total energy duty of 25 MJ/kg CO2, which is comparable to traditional TVSA desorption in terms of energy duty but significantly higher in terms of productivity. The study concludes that microwave desorption is an effective solution for overcoming heat transfer limitations present during more traditional thermal desorption processes that use polymeric sorbents.

### SUMMARY

The present disclosure includes solutions that include (1) utilizing a new DAC configuration that uses two adjacent filters and dampers with certain mechanisms which allows for regeneration without interrupting the indoor air supply; (2) creating a state-of-the-art filter design that allows part of air flow rate to interact with the adsorbent while the other part does not, resulting in the right desired condition after mixing the two streams; (3) running a simulation that calculates the energy consumption and efficiency of DAC unit for different locations in the AHU; and (4) applying an electrified heating device, like microwave heating, for CO2 regeneration which also will speed up the process, reduce the required regeneration energy, and benefit from the co-adsorption of water by the adsorbent.

The proposed DAC configuration with two adjacent filters and dampers offers a solution that allows for the uninterrupted supply of indoor air during CO2 regeneration, providing greater comfort for occupants and enhancing their productivity. This system gives flexibility to choose either a fixed bed reactor or a state-of-the-art filter base process, based on applications as well as the feasibility study of the system. The state-of-the-art filter design allows the air flow rate to interact with the adsorbent in the right proportion, resulting in the desired humidity and CO2 concentration, which meets the indoor air quality standards and saves more energy. The simulation of the energy consumption and efficiency of the DAC unit for different locations in the air handling unit optimizes the system's performance, resulting in a more energy-efficient system as a whole. The use of an electrified heating device like microwave heating reduces the required regeneration energy, and also benefits from the co-adsorption of water by the adsorbent, thereby making the CO2 regeneration process more efficient and effective.

Collectively, this proposed solution provides a more efficient, sustainable, and effective approach for DAC in air conditioning systems that maintains comfortable indoor air quality standards and saves more energy, thereby helping to achieve negative emission targets.

According to one non-limiting aspect of the present disclosure, an example embodiment of a DAC configuration within an AHU unit is provided. In one embodiment, the air handling unit includes at least one filter configured to filter the air, at least one cooler configured to cool the air to a low temperature, at least one heater configured to heat the air to a high temperature, and at least one humidifier configured to add moisture into the air.

Additional features and advantages are described herein, and will be apparent from the following Detailed Description and the figures.

### BRIEF DESCRIPTION OF THE FIGURES

Features and advantages of the present disclosure, including a design for DAC and HVAC integration described herein may be better understood by reference to the accompanying drawings in which:

FIG. 1 is a schematic diagram of a modified AHU, according to an embodiment of the present disclosure.

FIG. 2 is a schematic diagram of a CO2 filter position and design, according to an embodiment of the present disclosure.

FIG. 3 is a schematic diagram of the AHU and DAC integration with a possible location of the DAC unit, according to an embodiment of the present disclosure.

FIG. 4 is a graph illustrating the efficiency of the DAC unit at different positions within the AHU, according to an embodiment of the present disclosure.

FIG. 5 is a graph illustrating the energy consumption of both HVAC and DAC based on different locations within the AHU, according to an embodiment of the present disclosure.

The reader will appreciate the foregoing details, as with others, upon considering the following detailed description of certain non-limiting embodiments of the present disclosure.

### DETAILED DESCRIPTION

The present disclosure is generally related to a design for DAC and HVAC integration and involves the development of a prototype for testing two distinct modes of DAC units, namely filter-based and reactor-based, within an AHU.

The proposed prototype incorporates new DAC configurations that utilize dampers, filters, positioning of DAC in the AHU, and microwave heating for regeneration to facilitate the direct capture of CO2 within the HVAC system. The primary function of the present disclosure is to enable continuous airflow within the AHU, even during the material regeneration stage. The filter design leverages water adsorption and transforms it into a beneficial process, thus enabling the control of humidity and CO2 concentration. The optimized position of DAC units results in better DAC efficiency and a reduction in HVAC energy. The microwave heating component reduces the required regeneration energy, takes advantage of unwanted water co-adsorption, speeds up the rate of desorption, and facilitates the powering of DAC by renewable energy sources.

Microwave heating is a well-known phenomenon in which the microwave radiation interacts with the dipoles of a molecule, such as the separated positive and negative charge of water. This interaction leads to the back-and-forth movement of water molecules at the frequency of the microwaves, resulting in energy transfer to the water molecules. This phenomenon of vibrating water molecules is suitable for the filters proposed herein. In the proposed filter, an adsorbent that can adsorb water as well as CO2 to be able to control the humidity is utilized. While the co-adsorption of water may lead to higher regeneration energy, the unwanted co-adsorption of water inside the adsorbents can make microwave heating an efficient approach by leveraging dielectric and volumetric heating to bypass the heat transfer limitations of materials with poor thermal conductivity. Microwave heating usage as the regeneration method of CO2 in a direct air capture unit proved to be faster and consumes around 40% of the energy required by conventional heating in experiments conducted, the microwave proposed unit has never been used within HVAC systems as per the best of the knowledge of the inventors.

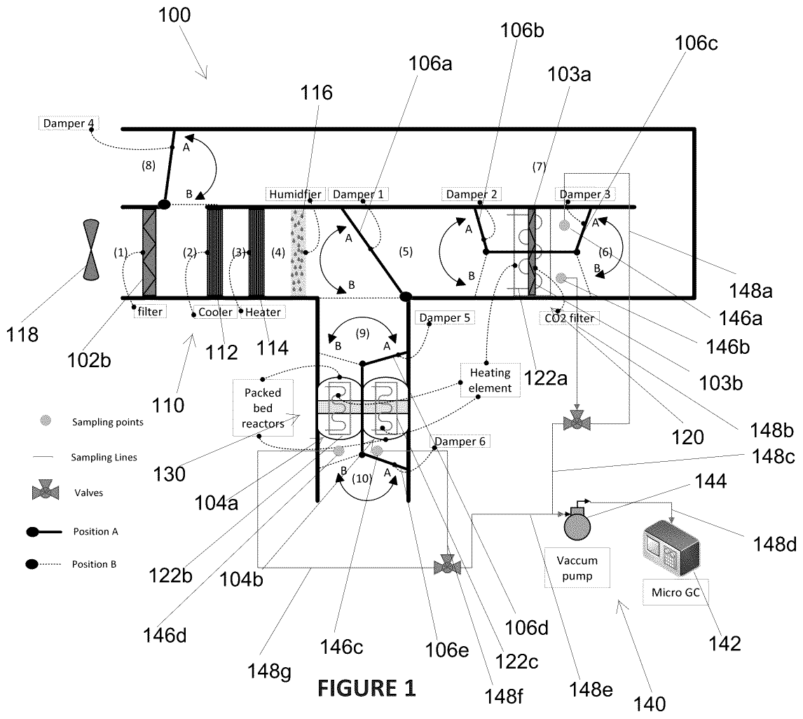

FIG. 1 illustrates a modified air handling unit 100 that incorporates DAC technology. The unit 100 can operate in two different modes, namely filter-based (CO2 capture via filters 103a, 103b) or reactor-based (CO2 capture through packed bed reactors 104a, 104b). In addition, FIG. 1 displays the recirculation mode of air. The diagram consists of four main parts, namely AHU components 110, filter-based DAC unit 120, packed bed reactor-based DAC unit 130, and gas screening part 140.

The first part, AHU components, comprises four points (1 to 4) and four units (filter 102, cooler 112, heater 114, and humidifier 116) to simulate AHU conditions. The air enters the AHU unit 110 at point 1 through a fan 118 and then passes through a filter 102 at point 2. The air is then cooled at a low temperature through a cooler 112 and heated by a heater 114 before reaching point 4. At point 4, the air can be directed to either point 5 or point 9 using a first damper 106a.

The second part, the filter-based DAC unit 120, is located between point 5 and 6 and consists of filters 103a, 103b, heating elements 122a (such as, but not limited to, induction heating, ohm heating, or microwave heating), and dampers 106b, 106c. The unit 120 has two filters 103a, 103b to ensure a continuous air flow even during CO2 regeneration. The air enters the unit from point 5 and passes through one of the two filters 103a, 103b based on the position of damper 106b, which position can be either A or B. If the damper 106b is in position A, then the air will pass through the filter 103b adsorbing the CO2 while the other filter 103a regenerates.

The third part, the packed bed reactor-based DAC unit 130, is located between points 9 and 10 and comprises two packed bed reactors 104a, 104b, two dampers 106d, 106e, and two heating elements 122b, 122c. If the air is directed from point 4 to point 9 using the first damper 106a, the CO2 in the air will be captured through the right or left packed bed reactor 104a, 104b, depending on the position of the dampers 106d, 106e.

The gas screening part 140 consists of micro gas chromatography (“GC”), vacuum pump 144, four sampling points 146a-146d (appearing as green circles in FIG. 1), and sampling lines 148a-148g. The sampling points 148a-148g are connected to the vacuum pump 144 and then to GC 142 for gas measurements.

Overall, FIG. 1 illustrates a modified air handling unit 100 that is capable of capturing CO2 using two distinct methods and has a recirculation mode of air available.

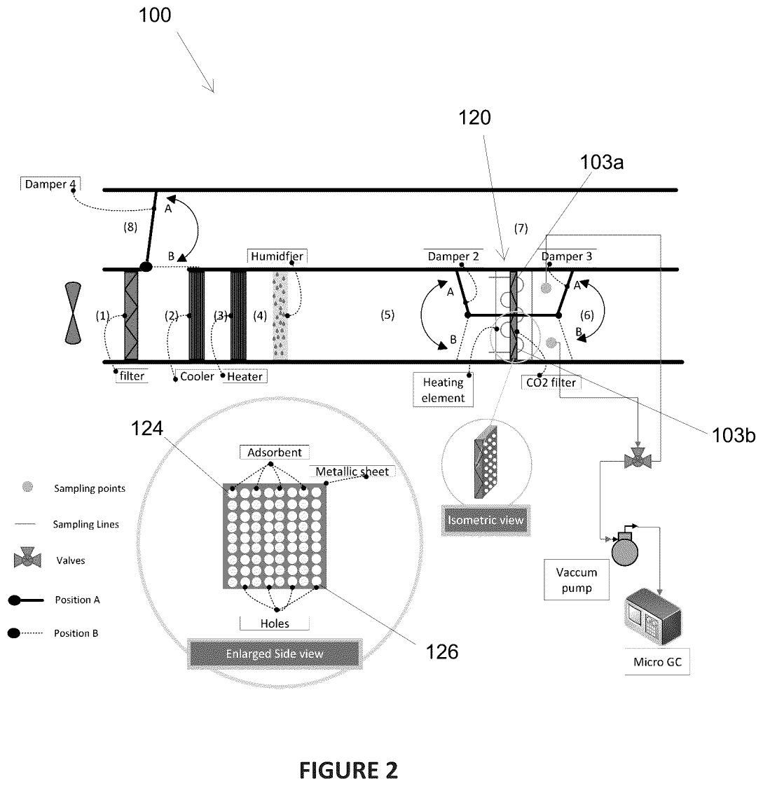

FIG. 2 depicts a CO2 filter 103a, 103b design specifically developed to capture CO2 using an HVAC system. Given the intended placement of the DAC unit 120 within the AHU 100 and the supply of DAC-treated air to indoor spaces, it is essential to regulate the humidity and CO2 concentration of the air. Based on comprehensive testing and screening of various adsorbents, it was observed that the treated air would have minimal or zero CO2 concentration, which is not conducive to indoor environments. Additionally, the humidity level of the air would vary widely, depending on the adsorbent type, necessitating further processing and energy expenditure before it could be supplied indoors. To address these challenges, the proposed filter 103a, 103b design is capable of regulating both the humidity and CO2 concentration.

The filter 103a, 103b is designed with two distinct air passes 124, 126: one (124) that incorporates the adsorbent material and another (126) that permits the passage of untreated air, as shown in the enlarged side view in FIG. 2. The passageways 124 containing the adsorbent material result in the near-complete removal of CO2 and a significant reduction in humidity, while the untreated air passageways 126 maintain their original CO2 concentration and humidity level. By adjusting the number of passes 124, 126 of each type and mixing the resultant air streams, the CO2 concentration and humidity of the indoor air is precisely regulated.

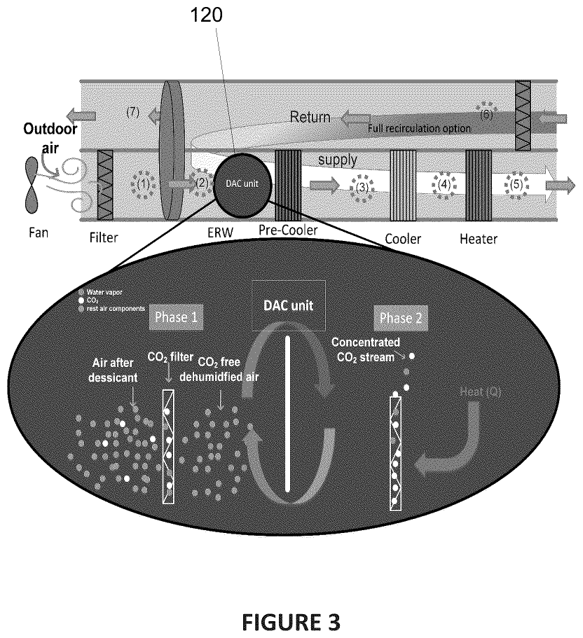

A numerical simulation was used to assess different integration configurations. Different points within an HVAC system's AHU were chosen to maximize the integration benefits. The performance of a DAC unit in six different locations within AHU was investigated and compared to stand-alone DAC unit. The possible locations of DAC unit 120 are in points 2-6 as shown in FIG. 3. The possible benefits of the integration which will affect the choice of the DAC unit 120 position include reducing indoor CO2 levels to improve indoor air quality, reduction in HVAC energy consumption by using higher air recirculation ratios, a more efficient DAC system by capturing CO2 from indoor air with higher concentrations, using humidity swings and cooler adsorption.

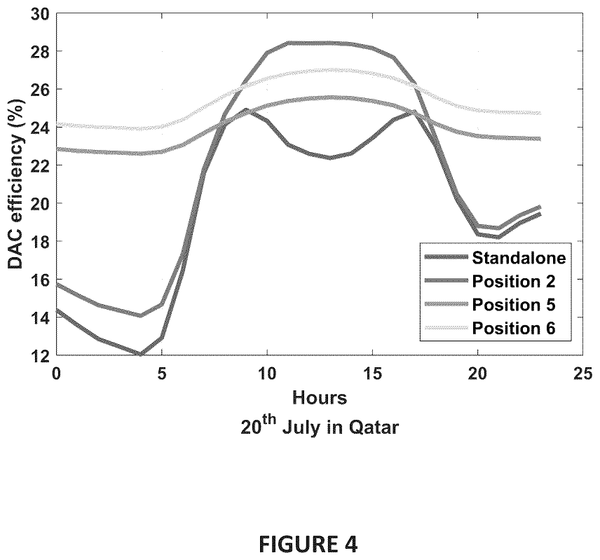

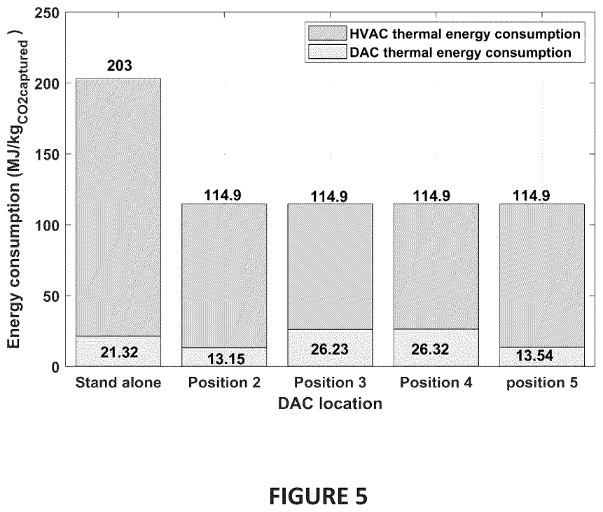

The efficiency of four DAC units 120 located at Positions 1, 2, 5, and 6 within FIG. 3 was simulated and the results of the simulation are presented in FIGS. 4 and 5. The simulation was conducted in the middle of summer, July 20, in Qatar. The efficiencies of Positions 3 and 4 were not considered in this analysis as they were found to be significantly lower compared to other positions. The highest efficiency was observed when the DAC unit was located at Position 2 during the midday hours when the temperatures were at their highest. However, during the cooler hours of the day, the efficiency of the stand-alone DAC unit (Position 1) was comparable to that of Position 2. Additionally, during these cooler hours, the efficiency of the DAC unit at Position 2 was found to be lower than that of Positions 5 and 6. It should be noted that while cooler temperatures result in improved DAC efficiencies, they are also associated with higher relative humidities, which can lead to increased regeneration energy and ultimately lower overall efficiency. The efficiencies of Positions 5 and 6 were found to be more consistent throughout the day. Note, the efficiency of the stand-alone DAC unit (Position 1) improved from 12% to 23.93% when it was positioned at Position 6 compared to stand-alone unit during the coldest temperature of 305° K and a relative humidity of 90% on July 20th at 4:00 AM in Qatar.

Utilizing a DAC unit within an AHU allows for reduction in cooling energy by increasing air recirculation ratios. By combining the use of a DAC unit with other air purification techniques, prior art suggests that full air recirculation for up to 10 hours can be achieved.

To calculate the energy savings, it was assumed that all supplied air is fully recirculated, and that the air does not pass through an energy recovery wheel as illustrated by the recirculation option in FIG. 3. The simulation shows a thermal energy reduction of 37% (from 203 to 114.9 MJ/kg CO2 captured) in cooling load for the 20th of July at 12:00 pm midday in Qatar as shown in FIG. 5. Furthermore, the study found that positioning a DAC unit in certain positions within an AHU can lead to a reduction in thermal energy consumption for the DAC system itself, with Position 2 (the same as Position 6 but in recirculation mode) achieving the least thermal energy consumption of 13.15 MJ/kgCO2 compared to 21.32 MJ/kgCO2 for a stand-alone DAC unit, a reduction of 38.4%.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An air handling unit to pass air through the air handling unit to regulate the air within an indoor space, comprising:
at least one filter configured to filter the air;
at least one cooler configured to cool the air;
at least one heater configured to heat the air;
at least one humidifier configured to add moisture into the air.

2. The air handling unit of claim 1, further comprising:
a direct air capture unit comprising:
at least one damper;
a plurality of carbon dioxide filters; and
a heating element.

3. The air handling unit of claim 2, wherein the at least one filter, the at least one cooler, the at least one heater, the at least one humidifier, and the direct air capture unit are disposed within a fluid pathway and configured to be in fluid communication with each other.

4. The air handling unit of claim 3, further comprising a first damper disposed between the direct air capture unit and at least one of the at least one filter, the at least one cooler, the at least one heater, and the at least one humidifier,
wherein the first damper is configured to allow fluid communication between the direct air capture unit and at least one of the at least one filter, the at least one cooler, the at least one heater, and the at least one humidifier in a first position, and to prevent fluid communication between the direct air capture unit and at least one of the at least one filter, the at least one cooler, the at least one heater, and the at least one humidifier in a second position.

5. The air handling unit of claim 2, wherein the direct air capture unit comprises second and third dampers, wherein the second damper is disposed on a first side of the heating element and the third damper is disposed on a second side of the heating element.

6. The air handling unit of claim 5, wherein the second and third dampers are configured to reside in a first direct air capture position or a second air capture position.

7. The air handling unit of claim 6, wherein when the second and third dampers reside in the first direct air capture position, the direct air capture unit is configured to allow air to pass through a first carbon dioxide filter and to prevent air from passing through a second carbon dioxide filter.

8. The air handling unit of claim 7, wherein when the second and third dampers reside in the second direct air capture position, the direct air capture unit is configured to allow air to pass through the second carbon dioxide filter and to prevent air from passing through the first carbon dioxide filter.

9. The air handling unit of claim 1, further comprising:
a packed bed reactor based direct air capture unit comprising:
at least one damper;
at least one heating element; and
a plurality of packed bed reactors.

10. The air handling unit of claim 9, wherein the packed bed reactor based direct air capture unit is disposed downstream of a first damper.

11. The air handling unit of claim 9, wherein the packed bed reactor based direct air capture unit comprises fourth and fifth dampers, wherein the fourth damper is disposed on a first side of the packed bed reactor based direct air capture unit and the fifth damper is disposed on a second side of the packed bed reactor based direct air capture unit.

12. The air handling unit of claim 11, wherein the fourth and fifth dampers are configured to reside in a first packed bed reactor position or a second packed bed reactor position.

13. The air handling unit of claim 12, wherein when the fourth and fifth dampers reside in the first packed bed reactor position, the packed bed reactor based direct air capture unit is configured to allow air to pass through a first packed bed reactor and to prevent air from passing through a second packed bed reactor.

14. The air handling unit of claim 13, wherein when the fourth and fifth dampers reside in the second packed bed reactor position, the packed bed reactor based direct air capture unit is configured to allow air to pass through the second packed bed reactor and to prevent air from passing through the first packed bed reactor.

15. The air handling unit of claim 2, wherein the air handling unit is part of a heating, ventilation, and air conditioning system.

16. A method of treating air comprising:
providing an air handling unit comprising:
at least one filter configured to filter the air;
at least one cooler configured to cool the air;
at least one heater configured to heat the air; and
at least one humidifier configured to add moisture into the air;
providing at least one direct air capture unit comprising:
at least one damper;
a plurality of carbon dioxide filters; and
a heating element; and
causing air to pass through the air handling unit and the at least one direct air capture unit.

17. The method of claim 16, further comprising:
causing a change in position of the at least one damper of the at least one direct air capture unit such that air is allowed to pass through a first carbon dioxide filter and is prevented from passing through a second carbon dioxide filter.

18. The method of claim 17, wherein the air handling unit is part of a heating, ventilation, and air conditioning system.

19. The method of claim 16, further comprising:
providing a packed bed reactor based direct air capture unit comprising:
at least one damper;
at least one heating element; and
a plurality of packed bed reactors.

20. The method of claim 19, further comprising:
causing a change in position of the at least one damper of the packed bed reactor based direct air capture unit such that air is allowed to pass through a first packed bed reactor and is prevented from passing through a second packed bed reactor.
